(19) United States
(12) Patent Application Publication
(10) Pub. No.: US 2026/0006414 A1
(43) Pub. Date: Jan. 1, 2026

(54) METHOD AND SYSTEM FOR INTEGRATED COMMUNICATION AND SENSING NETWORK SERVICES

(71) Applicant: AT&T Intellectual Property I, L.P., Atlanta, GA (US)

(72) Inventors: James H. Pratt, Round Rock, TX (US); Eric Zavesky, Austin, TX (US); Yupeng Jia, South Pasadena, CA (US)

(73) Assignee: AT&T Intellectual Property I, L.P., Atlanta, GA (US)

(21) Appl. No.: 18/756,087

(22) Filed: Jun. 27, 2024

(51) Int. Cl. H04W 4/38; G01D 18/00

(52) U.S. Cl. CPC H04W 4/38; G01D 18/00

(57) ABSTRACT

Aspects of the subject disclosure may include, for example, determining, based on an identified context, that there is a need for sensor-related operations, mapping the need to one or more sensors, receiving, from the one or more sensors, data associated with the sensor-related operations, resulting in received data, performing analytics on the received data by applying one or more filters thereto, and causing operational adjustments to be made to the one or more sensors based on the analytics. Other embodiments are disclosed.

### FIELD OF THE DISCLOSURE

The subject disclosure relates to facilitating integrated communication and sensing network services.

### BACKGROUND

As wireless communications technology continues to advance, the proliferation of Internet-of-Things (IoT) devices, such as sensors, will further accelerate. The sheer volume of data from “too many” sensors, however, will clog not only decision pathways, but also communication channels that are associated with network applications and user-based needs requests to assistants, environmental displays, and the like.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within, or operatively overlaid upon, the communications network of FIG. 1 in accordance with various aspects described herein.

FIG. 2B illustrates example functions and operational flows relating to a sensing service provider platform in the system of FIG. 2A, in accordance with various aspects described herein.

FIG. 2C depicts an illustrative embodiment of a method in accordance with various aspects described herein.

FIG. 3 is a block diagram illustrating an example, non-limiting embodiment of a virtualized communications network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments of a system that is configured to provide sensing as a service. The system may be implemented in a sensing service provider platform that is capable of communicating with and managing different types of sensors, including static sensors (e.g., stationary IoT devices) and moving sensors (e.g., wearable devices, mobile devices, etc.), located or operated within one or more environments. In exemplary embodiments, the sensing service provider platform may be capable of determining, based on an identified context, that there is a need for sensor-related operations, and mapping the need to one or more sensors. The sensing service provider platform may also be capable of receiving, from the one or more sensors, data associated with the sensor-related operations, and performing analytics on the collected data by applying one or more filters thereto. For instance, the sensing service provider platform may apply quality filter(s) to received sensor data to determine the accuracy, reliability, or security of the data. As another example, the sensing service provider platform may additionally, or alternatively, apply meta filter(s) to received sensor data to identify or determine the context, relevance, and/or importance of the data. In one or more embodiments, the sensing service provider platform may be capable of causing operational adjustments to be made to the one or more sensors based on the analytics. As an example, the sensing service provider platform may provide instructions to one or more of the sensors to adjust their operational characteristic(s) (e.g., on/off status, power level, sampling rate, etc.). As another example, the sensing service provider platform may provide results of some or all of the analytics to one or more of the sensors to enable them to make automated decisions with respect to their operational characteristic(s). As yet another example, the sensing service provider platform may provide qualification or validation information (according to quality and operational metrics) to individual sensors based on results of the analytics.

In various embodiments, the sensing service provider platform may additionally, or alternatively, be capable of generating information regarding the received data for presentation to user(s) or device(s). Such information can be useful for determining whether there is a need for additional or new sensors or if the sensor data can be merged with other sensing systems, such as autonomous vehicles for navigation purposes, etc. In one or more embodiments, the sensing service provider platform may additionally, or alternatively, be capable of tracking user or system engagement with the information to identify sensor usefulness, and deriving a summary concerning the user or system engagement. The summary can be provided (e.g., sold) to a secondary market (e.g., secondary users or systems that consume engineered/compounded sensors) as anonymized data for research or the like.

Exemplary embodiments of the sensing service provider platform advantageously address the issue of “too many sensors” generating an overwhelming amount of sensor data, by enabling sensors to self-determine and self-differentiate. This can be achieved by aggregating reports that help identify the most useful sensors, which allows for adjustments to be made to the number of sensors that are operated, thereby alleviating power-related, data-related, and financial-related concerns. A market-based approach to sensing data, as provided by embodiments of the sensing service provider platform, avoids the problem of sensor saturation and improves overall device sustainability, such that determinations can be made as to whether or when a sensor is no longer needed or has reached the end of its useful life, and such that sensors are deployed (e.g., only) where there is a genuine need for the data that they collect. Self- or centralized-audits can be performed to monitor various parameters, such as network usage (e.g., how sensors are using network resources), power usage (e.g., how much power the sensors are consuming), data utility (e.g., the perceived value of the data generated by the sensors), engagement (e.g., the level of user interaction with sensor-generated data), and/or the like, and identify needed operational adjustments.

While traditional communication services (e.g., phone, Internet) have been the norm, exemplary embodiments of the sensing service provider platform advantageously provide for sensing as a service by offering real-time (or near real-time) data and insights from sensors. Sensor devices themselves can benefit from this service by making autonomous decisions based on insights gathered for various sensors. This provides for self-healing or self-maintenance as well as improved user experiences.

Providing automated quality and operational metrics, as described herein, helps improve the performance of sensors and validate the data that they collect. In some embodiments, the sensing service provider platform may offer metrics that help inform IoT devices about their own operational parameters, such as timing and scheduling, frequency of data collection or processing, type of data being collected or processed, and/or the like, which can enable the IoT devices to improve or optimize their performance and/or the quality of the data that they collect. In certain embodiments, the sensing service provider platform may offer automated validation metrics for consumers of IoT data, which can help the consumers determine the trustworthiness of individual sensors. This may be done by way of a certification or label, such as “network certified fresh,” that indicates that a sensor provides high-quality and reliable data. Such validation enables other applications in the consumer/system space that require specific sensors or datasets to identify the sensors that they can or should rely on.

Embodiments of the sensing service provider platform better leverage edge node awareness and orchestration capabilities to create a more efficient and effective way of managing IoT devices and their data, which can pave the way for new opportunities in self-healing and self-provisioning that enable IoT devices to be more resilient, adaptable, and efficient. Embodiments of the sensing service provider platform also enable future integrations with additional IoT sensors and the data that they convey, such that, as new sensors are developed or added to a network, they can seamlessly integrate with existing sensors and systems, allowing for more comprehensive and accurate data collection and analysis.

The proliferation of data and service providers brings with it the need to localize and democratize the trust of data as it would be less practical in such a context to rely on centralized authorities to verify the trustworthiness of data. Exemplary embodiments of the sensing service provider platform described herein enable such democratization by permitting sensor devices (e.g., in collaboration with the sensing service provider platform itself) to perform evaluations and/or assign trust to the reliability (e.g. service level agreement (SLA)) and consistency (e.g. quality) of data.

As more sensors are deployed to collect and share data, there will be a growing need to manage the utility of such sensors (i.e., the ability of individual sensors or groups of sensors (joint data streams) to provide valuable insights, information, or services) as well as the redundancy of sensors (i.e., to ensure that multiple sensors contribute to data streams without duplicating efforts or causing conflicts). Of course, certain sensitive attributes, such as power use, data effectiveness, and engagement, can add complexity to such management. Sensors may have different energy requirements, which can affect their ability to operate efficiently. The quality and relevance of the data provided by each sensor may also vary, which can impact its usefulness. A sensor's ability to interact with other devices, systems, or people may also influence how the sensor contributes to data streams. Thus, the need for utility and redundancy management may change over time, leading to more nuanced decision-making when selecting sensors for specific applications, attempting to optimize sensor performance, or integrating sensors into larger systems. Exemplary embodiments of the sensing service provider platform described herein enable such nuanced sensor utility and redundancy management.

Exemplary embodiments of the sensing service provider platform described herein also enable the creation of more proactive and adaptive sensing environments based on predictions of the needs of users, services, and devices within a space. This allows for anticipation of (e.g., optimal) sensing requirements based on real-time (or near real-time) data and/or (e.g., recent) historical data, as well as improved (or optimized) sensor operations. Sensor operational adjustments may include, for instance, temperature control (e.g., where air conditioning (AC) systems can power up only when needed, rather than hours in advance), visual sensor management (e.g., where visual sensors can power down or switch to a lower sampling rate when low activity levels are predicted), and/or the like.

One or more aspects of the subject disclosure include a device, comprising a processing system including a processor, and a memory that stores executable instructions that, when executed by the processing system, facilitate performance of operations. The operations can include determining, based on an identified context, that there is a need for sensor-related operations. Further, the operations can include mapping the need to one or more sensors. Further, the operations can include receiving, from the one or more sensors, data associated with the sensor-related operations, resulting in received data. Further, the operations can include performing analytics on the received data by applying one or more filters thereto. Further, the operations can include causing operational adjustments to be made to the one or more sensors based on the analytics.

One or more aspects of the subject disclosure include a non-transitory machine-readable medium, comprising executable instructions that, when executed by a processing system of a sensor device including a processor, facilitate performance of operations. The operations can include receiving, from a sensing service provider platform, a request to perform sensing operations. Further, the operations can include performing the sensing operations based on the request, resulting in sensor data. Further, the operations can include transmitting the sensor data to the sensing service provider platform for analysis. Further, the operations can include responsive to the transmitting, receiving, from the sensing service provider platform, a command, generated based on the analysis, to adjust an operation of the sensor device. Further, the operations can include adjusting the operation of the sensor device based on the command.

One or more aspects of the subject disclosure include a method. The method can comprise determining, by a processing system including a processor, and based on an identified context, that there is a need for sensor-related operations in a particular environment. Further, the method can include mapping, by the processing system, the need to one or more sensors located in the particular environment. Further, the method can include obtaining, by the processing system, and from the one or more sensors, data associated with the sensor-related operations, resulting in obtained data. Further, the method can include performing, by the processing system, analytics on the obtained data by applying one or more filters thereto. Further, the method can include causing, by the processing system, operational adjustments to be made to the one or more sensors based on the analytics.

Other embodiments are described in the subject disclosure.

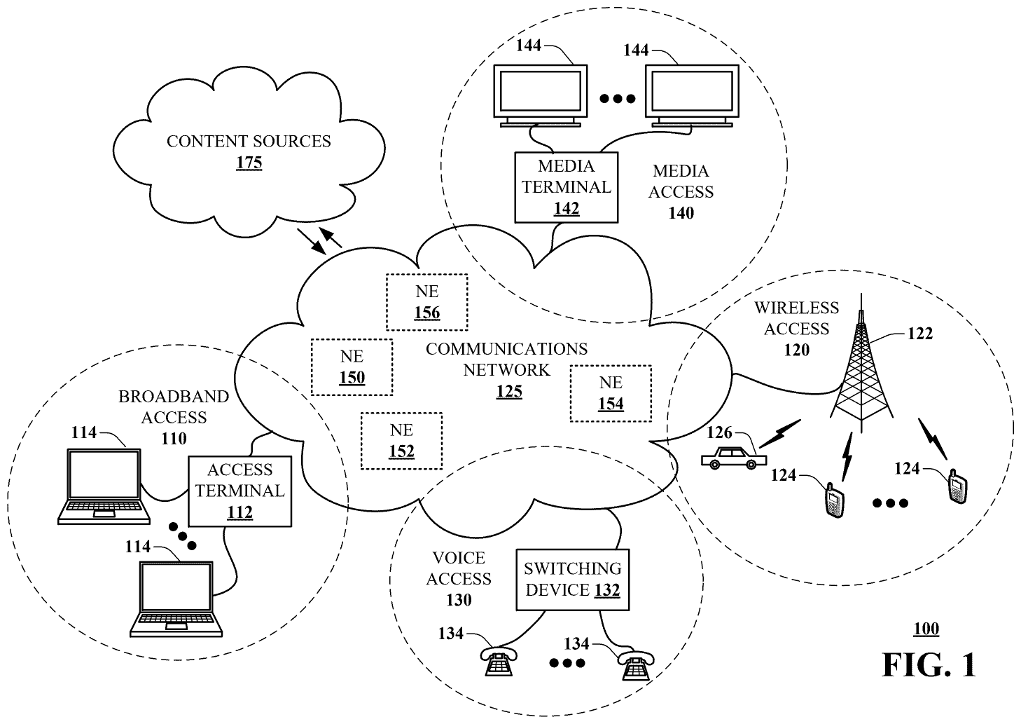

Referring now to FIG. 1, a block diagram is shown illustrating an example, non-limiting embodiment of a system 100 in accordance with various aspects described herein. For example, system 100 can facilitate, in whole or in part, integrated communication and sensing network services. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communications network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VOIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or another communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

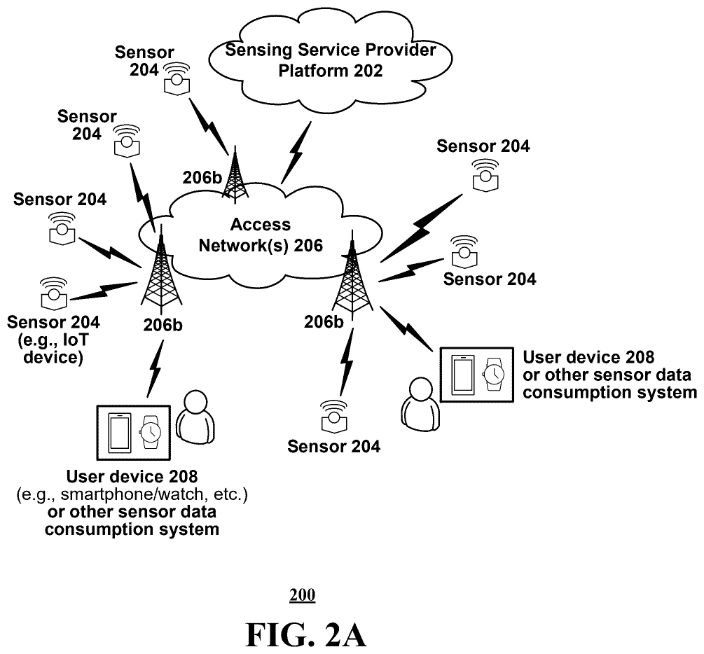

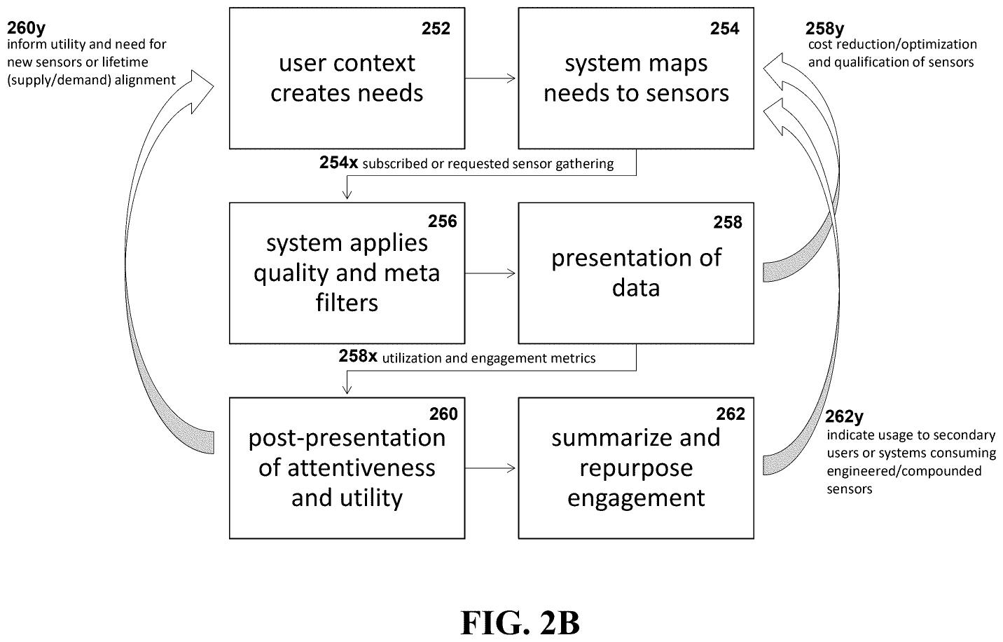

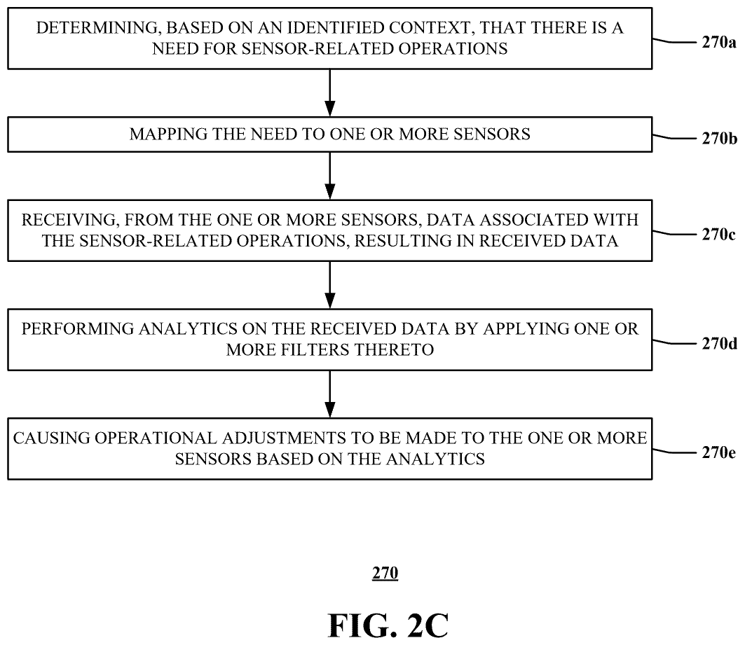

FIG. 2A is a block diagram illustrating an example, non-limiting embodiment of a system 200 functioning within, or operatively overlaid upon, the communications network 100 of FIG. 1 in accordance with various aspects described herein. The system 200 may include access network(s) 206 that facilitate communications between a sensing service provider platform 202 and various user devices 208 and sensors 204 located in one or more environments across one or more geographic areas.

In various embodiments, access network(s) 206 may include one or more wireless radio access networks (RANs), one or more Wi-Fi networks, and/or one or more wireline networks. In exemplary embodiments, the access network(s) 206 may be implemented in open source software (e.g., in an OpenAirInterface (OAI) wireless technology platform). The access network(s) 206 may include network resources, such as one or more physical access resources and/or one or more virtual access resources. Physical access resources can include base station(s) (e.g., one or more eNodeBs, one or more gNodeBs, or the like, such as base stations 206b), one or more satellites, one or more Gigabyte Passive Optical Networks (GPONs) or related components (e.g., Optical Line Terminal(s) (OLT), Optical Network Unit(s) (ONU), etc.), and/or the like. A base station 206b may employ any suitable radio access technology (RAT), such as 4G/LTE, 5G, 6G, or any higher generation RAT. One or more edge computing devices (e.g., multi-access edge computing (MEC) devices or the like) may also be included in or associated with the access network(s) 206. Virtual access resources can include a voice service system (e.g., a hardware and/or software implementation of voice-related functions), a video service system (e.g., a hardware and/or software implementation of video-related functions, such as coder-decoder or compression-decompression (CODEC) components or the like), a security service system (e.g., a hardware and/or software implementation of security-related functions), and/or the like. In one or more embodiments, the access network(s) 206 may include any number/types of physical/virtual access resources and various types of heterogeneous cell configurations with various quantities of cells and/or types of cells.

In certain embodiments, the access network(s) 206 may be implemented as one or more virtual RANs, where radio/wireline functions are implemented as general-purpose applications/apps that operate in virtualized environments and interact with physical resources either directly or via full/partial hardware emulation. Virtualized software radio applications can be delivered as a service and managed through a cloud controller. Here, base stations 206b may be implemented as (e.g., passive) distributed radio elements connected to a centralized baseband processing pool. In some embodiments, the access network(s) 206 may include, or communicate with, one or more RAN intelligent controllers (RICs).

Although not shown, the network 200 may include a core network. The core network may include network devices and/or systems that provide a variety of functions. In certain embodiments, the core network may be implemented in a cloud architecture. Examples of functions provided by, or included, in the core network include an access mobility function (AMF) configured to facilitate mobility management in a control plane of the network 200 (including, for instance, providing user device (or UE) mobility information associated with the access network(s) 206 and/or the user devices 208 (or UEs) to the core network), a user plane function (UPF) configured to provide access to a data network, such as a packet data network (PDN), in a user (or data) plane of the network 200, a Unified Data Management (UDM) function, a Session Management Function (SMF), a policy control function (PCF), and/or the like. The core network may be in communication with one or more other networks (e.g., one or more content delivery networks (CDNs)), one or more services, and/or one or more devices. In one or more embodiments, the core network may include one or more devices implementing other functions, such as a master user database server device for network access management, a PDN gateway server device for facilitating access to a PDN, and/or the like. The core network may include various physical/virtual resources, including server devices, virtual environments, databases, and so on.

The user devices 208 may be or may include a communication device (e.g., a router, a modem, a mobile phone, or a wearable device, such as a smart wristwatch, a pair of smart eyeglasses, media-related gear (e.g., augmented reality (AR), virtual reality (VR), or mixed reality (MR) glasses and/or headset/headphones)) a similar type of device, a different type of device, or a combination of some or all of these devices. The user devices 208 may (e.g., each) be equipped with a sensor service user interface (a graphical user interface (GUI) or the like) for interacting with the sensing service provider platform 202, such as to submit requests for sensor-related information, view sensor data, manage sensor-related preferences, and so on.

The sensors 204 may include any type of sensor (or more generally, IoT device). A given sensor 204 may be or may include a communication device, an electrical switch controller, a security camera, an automated assistant, a smart TV, an environmental sensor/controller (e.g., for lighting, temperature, audio, etc.), a kitchen/bath appliance controller (e.g., for a stove, a dehumidifier, etc.), a drapery (e.g., curtain, shade, blinds, or the like) controller, a location device, a vehicle, a similar type of device, a different type of device, or a combination of some or all of these devices. The sensors 204 may be configured to obtain (e.g., sense) data and provide the data (or derivatives thereof) to the sensing service provider platform 202 and/or the user devices 208 for analysis/consumption.

In exemplary embodiments, the sensing service provider platform 202 may be implemented in one or more devices included in the core network. For example, in a case where the core network includes an evolved packet core (EPC), the sensing service provider platform 202 may include, or may be implemented in, a mobility management entity (MME) gateway, a serving gateway (SGW), or another EPC system or device. As another example, in a case where the core network includes a 5G core (5GC), the sensing service provider platform 202 may include, or may be implemented in, an AMF or another 5GC system or device. In various embodiments, the sensing service provider platform 202 may be implemented in a centralized network hub or node device at, or proximate to, an edge of a network provider's overall network. In some embodiments, the sensing service provider platform may be implemented in a MEC device or devices. As the name/nomenclature implies, a MEC device may reside at a location that is at, or proximate, to an edge of the network 200, which may be useful in reducing (e.g., minimizing) delays associated with provisioning of data or services to one or more (requesting) devices. In some embodiments, the sensing service provider platform 202 may additionally, or alternatively, be implemented in a Self-Organizing Network (SON) or other similar network that provides automatic planning functions, configuration functions, optimization functions, diagnostic functions, and/or healing functions for a network. In some embodiments, the sensing service provider platform 202 may additionally, or alternatively, be implemented in a RIC or other similar device or device(s) that leverage data analytics and machine learning and/or artificial intelligence to provide resource management capabilities, such as mobility management, admission control, and interference management, at an edge of a network.

FIG. 2B illustrates example functions and operational flows relating to the sensing service provider platform 202, in accordance with various aspects described herein. Different user contexts may be associated with different sensor-related needs (block 252). In a given space or environment, there may be one or more users and one or more static/moving sensors 204. Sensor(s) 204 may be attached to a user (e.g., a watch, a fitness monitoring device, etc.) or installed in the space (e.g., an ambient sensing device, a camera, etc.). A given user may express a need (e.g., to know how many people are in a mall at this moment), which can be conveyed conversationally or based on historical information associated with the user (e.g., the user always goes to the pizza shop after work). A need may be passive (e.g., a user-based IoT device expresses a need to answer a larger user request). Identifying the context may inform on the need for sensor-related specifics, such as sensor depth to cover the size of a given space. In one or more embodiments, the sensing service provider platform 202 may be capable of determining, based on an identified context, that there is a need for sensor-related operations. The sensing service provider platform 202 may identify the context based on received commands or requests from user device(s) 208 or other systems, based on historical data, based on artificial intelligence (AI) predictions, and/or the like.

In various embodiments, the sensing service provider platform 202 may be capable of mapping the need to one or more sensors 204 (block 254). Sensors 204 may advertise their availability to perform sensing either periodically or respond based on a command from the sensing service provider platform 202. Sensors 204 may also provide information regarding their supported data types (e.g., audio from captured sound, videos from captured images, descriptive data from captured scents, etc.). A need may be mapped to particular data types, and thus some or all of the available sensors 204 that support those data types. In some embodiments, the sensing service provider platform 202 may associate product- or situation-specific data with responses from sensors (e.g., a sensor in a particular vending machine indicated that a certain desired product is fully stocked) for answering a determined user need.

In one or more embodiments, the sensing service provider platform 202 may be capable of receiving, from the one or more sensors 204, data associated with the sensor-related operations. In various implementations, these sensors may include those that have been mapped to the determined need. Sensors 204 may individually reply or provide sensor data, or may reply or provide sensor data as a group or community (e.g., as a best-of-service) provider. The sensors may include those that have been subscribed to by user(s) to utilize to service the need or those in a group of sensors that have been requested to service the need (step 254x). For instance, in various embodiments, the sensing service provider platform 202 may facilitate user or device subscriptions to different types of sensor data related to certain functions (e.g., detecting crowdedness in an area, humidity levels in an area, etc.). Users or devices 208 may subscribe to data from a particular sensor 204 or a group of sensors 204, such as all temperature sensors in a given location. Users or devices 208 may additionally, or alternatively, subscribe to data from sensors 204 within a specific area or zone. Users or devices 208 may choose the type of data that they wish to receive (e.g., class of function, such as raw sensor readings, processed metrics like “crowdedness” scores, alerts for specific conditions, and so on). In some implementations, the sensing service provider platform 202 may restrict access to certain data streams based on a user device 208's network connection status and/or location. Where a user subscription is manifested as a wearable device, the wearable device may be communicatively coupled to the sensor system to obtain and present real-time (or near real-time) information from various sensors across the user's footprint, which can avoid the need for the user to collect data from numerous different sensor subscriptions.

In one or more embodiments, the sensing service provider platform 202 may be capable of performing analytics on the received data by applying one or more filters thereto (block 256). For instance, the sensing service provider platform 202 may be capable of applying quality filter(s) to received sensor data to determine the accuracy, reliability, or security of the data. The quality filter(s) may be tuned to compare the quality of received sensor data with that of historical sensor data to identify sensor accuracy/reliability or to identify whether the corresponding sensor addressed the determined need. The quality filter(s) may additionally, or alternatively, be tuned to identify a cost associated with the sensor data (e.g., high sensor power usage due to high sensor data bursts). A quality filter may also be configured to analyze the security of the data-either in its traversed network path (e.g., only via secure, high-encryption network endpoints) or a signature embedded in the data itself (e.g., a cryptographically signed financial transaction). Determined quality of data from a given sensor may be joined against historical data to identify a status for the sensor (e.g., the sensor may be assigned “trusted” or “celebrity” status if its sensor data is deemed to satisfy threshold(s) for official heating, ventilation, and air conditioning (HVAC) accounting). The sensing service provider platform 202 may additionally, or alternatively, be capable of applying meta filter(s) to received sensor data. The meta filter(s) may be tuned to identify or determine the context, relevance, and/or importance of the data. The meta filter(s) may additionally, or alternatively, be tuned to identify a group (or community) to which a given sensor belongs or any subscriptions/memberships associated with the sensor (e.g., users or devices 208 may have subscribed to receive the data feed of the sensor).

In one or more embodiments, the sensing service provider platform 202 may be capable of causing operational adjustments to be made to the one or more sensors 204 based on the analytics. As one example, the sensing service provider platform 202 may provide instructions to one or more of the sensors 204 to adjust their operational characteristic(s) (e.g., on/off status, power level, sampling rate, etc.). As another example, the sensing service provider platform 202 may provide results of some or all of the analytics to one or more of the sensors 204 to enable them to make automated decisions with respect to their operational characteristic(s). As yet another example, the sensing service provider platform 202 may provide qualification or validation information (according to quality and operational metrics) to individual sensors 204 based on results of the analytics.

In various embodiments, the sensing service provider platform 202 may be capable of generating information regarding the received data for presentation to user(s) or device(s) (block 258). Such information can be useful for determining whether there is a need to disable sensors in a given area (e.g., if they are not being used), which can conserve power and reduce bandwidth consumption and competition for communication channels. In some instances, a need may be contextually updated or refreshed by context. For instance, a temperature sensor located in a specific room in a home may be different from those located in other rooms, and thus a requested temperature reading of the home may need to take into account the temperature data provided by the various sensors. In one or more embodiments, the sensing service provider platform 202 may consider specific characteristics of different sensors (e.g., their range, sensing capabilities, accuracy, longevity, and/or the like) and sample them to obtain a full visual/non-visual spectra. In this way, the sensing service provider platform 202 can collect and integrate data from multiple sensors to obtain a more detailed and comprehensive understanding of the environment. In certain implementations, the sensing service provider platform 202 may allow a user or system to question or inspect qualifications of source, and may provide additional information in this regard. For example, in a case where a user or system does not believe or does not accept a provided temperature reading, and submits a request to obtain a second opinion, the sensing service provider platform 202 may provide statistics on individual data that was used to obtain the overall temperature reading and/or any other additional information that the sensing service provider platform 202 used to arrive at the temperature reading. Of course, a user or system may choose to ignore/suppress certain sensor-related data/feedback, as desired.

In various embodiments, the sensing service provider platform 202 may be capable of tracking user or system engagement with the information to identify sensor usefulness. The sensing service provider platform 202 may use metrics such as attentiveness and/or utility to determine the usefulness or relevancy of sensors. As some examples, the sensing service provider platform 202 may track user or system usage of generated sensor information, user or system feedback/trust of the generated sensor information (e.g., user recommendations for specific sensors 204 or user selections of certain sensors 204 or aggregated data streams for a given session as favorites), user or system sharing of the sensor information, user or system requested enforcement of quality due to unreliable sensor information, and/or the like.

In one or more embodiments, the sensing service provider platform 202 may be capable of generating additional information regarding the user or system engagement (block 260). Such information can be useful for determining whether there is a need for additional or new sensors or if the sensor data can be merged with other sensing systems, such as autonomous vehicles for navigation purposes, etc. From a self-evaluation or mean time between failures (MTBF) replacement standpoint, the information can provide insights into whether or when a particular sensor 204 may need to be replaced or whether or when redundant sensor systems may need to be implemented, which can help improve or optimize system performance by reducing or minimizing downtimes. In one or more embodiments, the sensing service provider platform 202 may be capable of deriving a summary of the additional information (block 262), which can be provided (e.g., sold) to a secondary market (e.g., secondary users or systems that consume engineered/compounded sensors) as anonymized data for research or the like. Of course, individual users may be given the opportunity to opt-in/opt-out of having their associated engagement metrics be utilized in analysis or shared with others.

In certain example implementations, the sensing service provider platform 202 may be configured to perform adaptive monitoring of sensing data. The sensing service provider platform 202 may, based on received sensor data from a sensor 204, perform an analysis relating to the received sensor data. For instance, the sensing service provider platform 202 may compare the received sensor data and historical sensor data to determine whether a difference between the received sensor data and the historical sensor data (e.g., differences in their amount of data, differences in a measured quality such as resolution, and/or the like) is less than a predetermined threshold. As another example, the sensing service provider platform 202 may additionally, or alternatively, receive user or system feedback/engagement data (e.g., from a user device 208) in the form of a rating. In this case, the sensing service provider platform 202 may determine whether the rating exceeds a particular threshold. Where the sensing service provider platform 202 determines that the difference between the received sensor data and the historical sensor data is not less than the predetermined threshold and/or that the user or system feedback/engagement rating does not exceed the particular threshold, the sensing service provider platform 202 may obtain additional information from the sensor 204. This additional information may relate to the sensor 204's status at the time of the sensing, such as available bandwidth associated with the sensor 204, a processing load of the sensor 204, power usage of the sensor 204, network connectivity of the sensor 204, a temperature of the sensor 204, and/or the like. The sensing service provider platform 202 may analyze this information to identify potential factors that may have affected the sensor 204's performance, which can inform the sensing service provider platform 202 on particular adjustments that can be made for the sensor 204 (e.g., updating firmware in the sensor 204, upgrading an access network 206 associated with the sensor 204, installing or increasing an amount of cooling provided to the sensor 204 to prevent overheating, etc.). The sensing service provider platform 202 may then provide data regarding such adjustments to the sensor 204 and/or its management system for implementation. In this way, the sensing service provider platform 202 may limit its collection of additional information relating to the sensor 204 to when the initially obtained sensor data reflects a poor or abnormal condition. This reduces excess requests for data, which avoids excess traffic volume over the network that could otherwise negatively impact network performance. The additional collected information can be used to analyze the cause of the poor or abnormal condition, thereby providing an improvement over existing sensor systems, resulting in a practical application that improves sensor performance monitoring.

Exemplary embodiments of the sensing service provider platform 202 can be applied in various use cases. As one example, the sensing service provider platform 202 can be implemented to provide a service that benefits IoT devices as a “customer” or “client.” In this example, the sensing service provider platform can be implemented to provide a network-based data collection service that provides insight into the quality of data being collected and/or the quantity of data being collected from various sources, such as local sensors. The quality of data may refer to the characteristics or properties of something, such as, for instance, the diversity of signals between local sensors, and the quantity of data may refer to the amount or magnitude of something, such as, for instance, the amount of downtime experienced. Continuing the example, the sensing service provider platform 202 can additionally, or alternatively, be implemented to provide a service that offers a rating or scoring system for sensors based on their performance and characteristics, where the ratings can be used to provide certain benefits to the highly-rated sensors, such as faster data processing or transmission, priority access to system resources, enhanced security or authentication measures, caching of data for improved response times and reduced load on underlying systems, guaranteed/assured system availability for the sensors, and/or the like. The service may automatically assign indicators to such highly-rated sensors to signify their premium status as well as to imply a certain level of trust, authenticity, or credibility to these sensors. By offering such benefits, the service can incentivize sensor manufacturers/providers to strive for excellent sensor performance, reliability, and quality. Further continuing the example, the sensing service provider platform can additionally, or alternatively, be implemented to provide a service that helps a service provider (e.g., a network operator or a cloud platform provider) improve or optimize their infrastructure to support the increasing demands of IoT devices. The sensing service provider platform 202 can provide recommendations for when to burst data payloads and when to sleep, the type of data that is currently most in demand, and/or the like, which can address a service provider's concerns with respect to bandwidth, power, and compute. Still further continuing the example, the sensing service provider platform 202 can be implemented to provide a service that facilitates upgrading, updating, and/or migration of IoT devices. The sensing service provider platform 202 may generate deployment recommendations in response to demand (e.g., upgrading sensors due to increased user presence at a location, shifting of sensor focus from one portion of an area with decreasing user presence to another portion that has increasing user presence, etc.). This is more valuable or effective than simply providing alert monitoring, as it enables self-automation as well as self-healing in the management of IoT devices, with little to no administrator input. The sensing service provider platform 202 may additionally, or alternatively, facilitate fine-tuning or refining of sensors 204 to improve their performance and accuracy, which can advantageously create a positive impression among users that the sensors are continually improving and self-optimizing (e.g., “scent sensors in certain malls have been updated recently so that I know where the good smelling locations are”).

In another example, the sensing service provider platform 202 may be configured to gather data on consumer behavior and preferences so as to create a “gig economy” of sorts for sensors. For business entities, the sensing service provider platform 202 can function as a complement to retail analytics by using sensor data to obtain information about customer behavior in different locations (e.g., stores, malls, etc.), such as the products or services that the customers are most interested in, brand affinity, and so on, which the business entities can utilize to make informed decisions on which products to offer at which locations. For individual consumers, the sensing service provider platform 202 can compare sensor data to identify similarities between consumers, and generate recommendations to consumers regarding the products or services that other similar consumers have expressed interest in.

Numerous other use cases of the sensing service provider platform 202 include, for instance, facilitating future mall experiences (e.g., where multiple IoT devices in the area can perform sensing for both users and local businesses to draw affinity for one or more experiences), highlighting specific products that are available for sale in a given area, enabling crowd x-raying/perception to allow visualization or understanding of what is in a nearby location, identifying social events or experiences near a location (e.g., mall, park, etc.) that a user may be interested in, acquiescing items (e.g., toys, games, food, etc.) that are available in a particular place (e.g., a friend's home) via localized access to a sensor data community in that environment, etc.

In some embodiments, the sensing service provider platform 202 may enable sensors 204 to solicit or advertise themselves to users or systems to increase their visibility and influence. The ability for a sensor 204 to solicit or advertise itself may be particularly relevant where multiple sensors of different brands or providers are present in a given area. To provide such a feature, the sensing service provider platform 202 may create profiles for each sensor 204, including information regarding its capabilities, accuracy, and/or reliability, which can be used to advertise the sensor's strengths and differentiate it from other sensors. The sensing service provider platform 202 may develop an advertising framework that allows sensors 204 to create targeted ads to users or systems. For example, a Sony-branded sensor in New York City may determine to advertise itself as the most authoritative temperature sensor in the area. The sensing service provider platform 202 may map user interests and preferences to specific sensors or data streams. In this way, if the sensing service provider platform 202 determines that a user or system is interested in information about a particular area (e.g., New York City), the sensing service provider platform 202 may promote one or more sensors 204 (e.g., the Sony-branded sensor) as primary sensor source(s) for that region. In various embodiments, the sensing service provider platform 202 may enable sensors 204 to send targeted messages to users or systems that are determined to be interested in their data feeds. For instance, the Sony-branded sensor might be able to send a user or system a message that highlights its sensing accuracy and reliability based on an expressed interest from the user or system in New York City temperature data.

In one or more embodiments, the sensing service provider platform 202 may provide a sensor sourcing feature that enables a user to intentionally select and surface available sensors on their user device 208. For instance, the user device 208 may, via the sensing service UI, accept a user request to assign one or more sensors to a particular location on the interface (e.g., a particular corner on a Heads-Up Display (HUD) or other visualization platform) for ease of viewing, and may cause data streams from those one or more sensors to be presented at the particular location on the interface.

In certain embodiments, the sensing service provider platform 202 may enable sensors 204 to impose the receipt of their data based on importance or relevance to a user or system. For instance, the sensors 204 may dynamically adjust their data transmission priority based on user-specific criteria, such as a temperature threshold for a child or a motion-based threshold for a sick pet. When the threshold is reached, the sensor may “barge in” and transmit its data immediately. This adaptive prioritization enables sensors to effectively “interrupt” other less urgent transmissions.

In various embodiments, the sensing service provider platform 202 may leverage AI to perform continuous quality checks on data streamed from various sensors, by utilizing locally trained and predicted models to assess the accuracy and reliability of the data in real-time or near real-time. This assessment process enables the sensing service provider platform 202 platform to assign a community-based trust score to a given sensor 204's data, effectively creating a metadata layer that captures the qualifications and veracity of each sensor 204's output (e.g., vision sensor X did not detect a person, but vision sensor Y did).

In one or more embodiments, the sensing service provider platform 202 may create a predictive model using machine learning algorithms that is trained (on historical sensor data and/or other relevant information) to make predictions about future sensor readings when no new data is available (e.g., when a sensor 204 is off-line or is in between updates). This advantageously reduces the need for frequent updates from each sensor 204, thereby reducing costs and resource usage. This also allows for more efficient processing of data, as the sensing service provider platform 202 can use the predicted values to fill in gaps or make estimates when actual data is not available.

In various embodiments, threshold(s) may be utilized as part of determining/identifying one or more actions to be taken or engaged. The threshold(s) may be adaptive based on an occurrence of one or more events or satisfaction of one or more conditions (or, analogously, in an absence of an occurrence of one or more events or in an absence of satisfaction of one or more conditions).

In one or more embodiments, AI or ML algorithm(s) described herein may be configured to reduce any error in the derivations of associations/mappings, predictions of optimal (best) chains, appropriate action(s) to take, and so on. In this way, any error that may be present may be provided as feedback to the algorithm(s), such that the error may tend to converge toward zero as the algorithm(s) are utilized more and more.

It is to be understood and appreciated that, although one or more of FIGS. 1, 2A, and 2B might be described above as pertaining to various processes and/or actions that are performed in a particular order, some of these processes and/or actions may occur in different orders and/or concurrently with other processes and/or actions from what is depicted and described above. Moreover, not all of these processes and/or actions may be required to implement the systems and/or methods described herein. Furthermore, while various components, devices, systems, modules, networks, platforms, etc. may have been illustrated in one or more of FIGS. 1 and 2A as separate components, devices, systems, modules, networks, platforms, etc., it will be appreciated that multiple components, devices, systems, modules, networks, platforms, etc. can be implemented as a single component, device, system, module, network, platform, etc., or a single component, device, system, module, network, platform, etc. can be implemented as multiple components, devices, systems, modules, networks, platforms, etc. Additionally, functions described as being performed by one component, device, system, module, network, platform, etc. may be performed by multiple components, devices, systems, modules, networks, platforms, etc., or functions described as being performed by multiple components, devices, systems, modules, networks, platforms, etc. may be performed by a single component, device, system, module, network, platform, etc.

FIG. 2C depicts an illustrative embodiment of a method 270 in accordance with various aspects described herein.

At 270a, the method can include determining, based on an identified context, that there is a need for sensor-related operations. For example, the sensing service provider platform 202 can, similar to that described above with respect to FIGS. 2A and/or 2B, perform one or more operations that include determining, based on an identified context, that there is a need for sensor-related operations. In some implementations, the sensing service provider platform 202 can determine that there is the need for sensor-related operations based on one or more thresholds being satisfied. The threshold(s) can be values or other criteria that can be objectively determined, such as a number of requests submitted by a user device 208 for particular metrics, an amount of time that has passed since a prior requested was submitted by a user device 208, a number of user devices 208 that are request particular metrics over a particular time period, etc.

At 270b, the method can include mapping the need to one or more sensors. For example, the sensing service provider platform 202 can, similar to that described above with respect to FIGS. 2A and/or 2B, perform one or more operations that include mapping the need to one or more sensors.

At 270c, the method can include receiving, from the one or more sensors, data associated with the sensor-related operations, resulting in received data. For example, the sensing service provider platform 202 can, similar to that described above with respect to FIGS. 2A and/or 2B, perform one or more operations that include receiving, from the one or more sensors, data associated with the sensor-related operations, resulting in received data.

At 270d, the method can include performing analytics on the received data by applying one or more filters thereto. For example, the sensing service provider platform 202 can, similar to that described above with respect to FIGS. 2A and/or 2B, perform one or more operations that include performing analytics on the received data by applying one or more filters thereto.

At 270e, the method can include causing operational adjustments to be made to the one or more sensors based on the analytics. For example, the sensing service provider platform 202 can, similar to that described above with respect to FIGS. 2A and/or 2B, perform one or more operations that include causing operational adjustments to be made to the one or more sensors based on the analytics.

While for purposes of simplicity of explanation, the respective processes are shown and described as a series of blocks in FIG. 2C, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

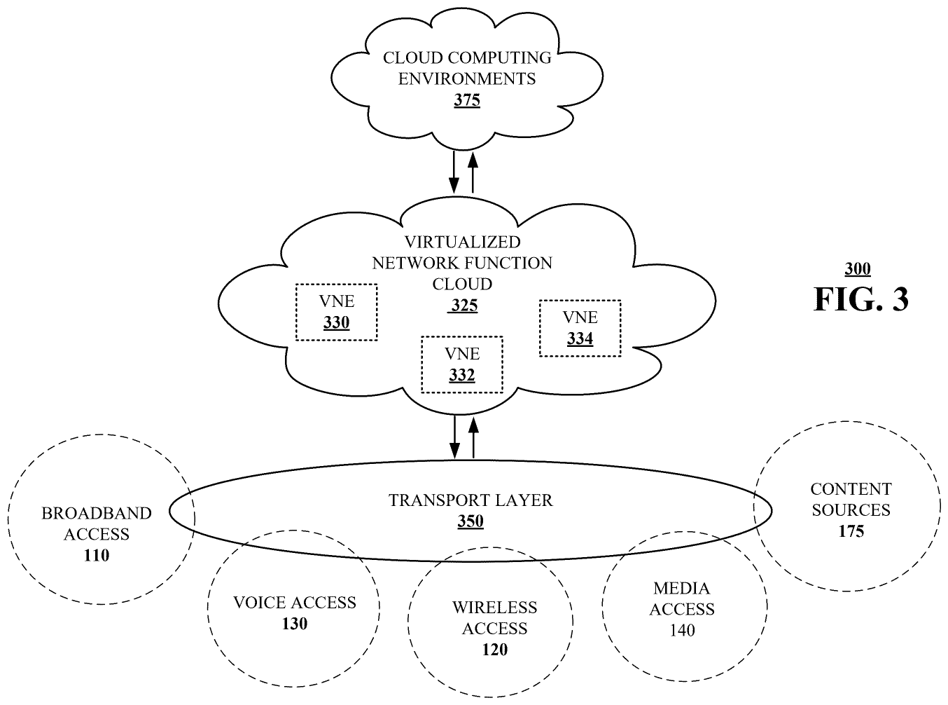

Referring now to FIG. 3, a block diagram 300 is shown illustrating an example, non-limiting embodiment of a virtualized communications network in accordance with various aspects described herein. In particular, a virtualized communications network is presented that can be used to implement some or all of the subsystems and functions of system 100, the subsystems and functions of system 200, and methods presented in FIGS. 1 and 2A-2C. For example, virtualized communications network 300 can facilitate, in whole or in part, integrated communication and sensing network services.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communications network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward substantial amounts of traffic, their workload can be distributed across a number of servers—each of which adds a portion of the capability, and which creates an overall elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

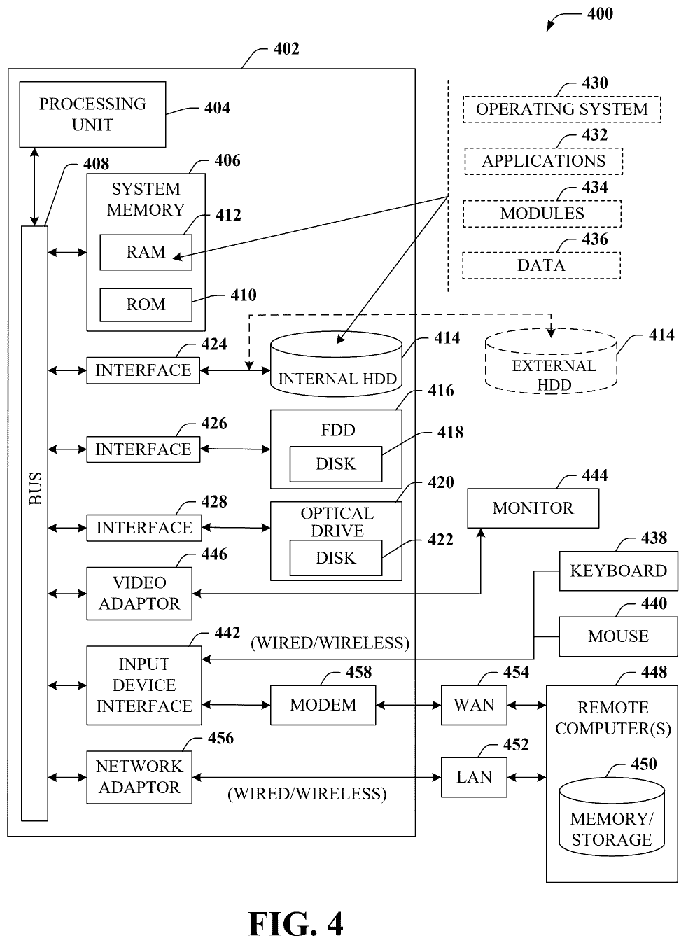

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate, in whole or in part, integrated communication and sensing network services.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communications network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

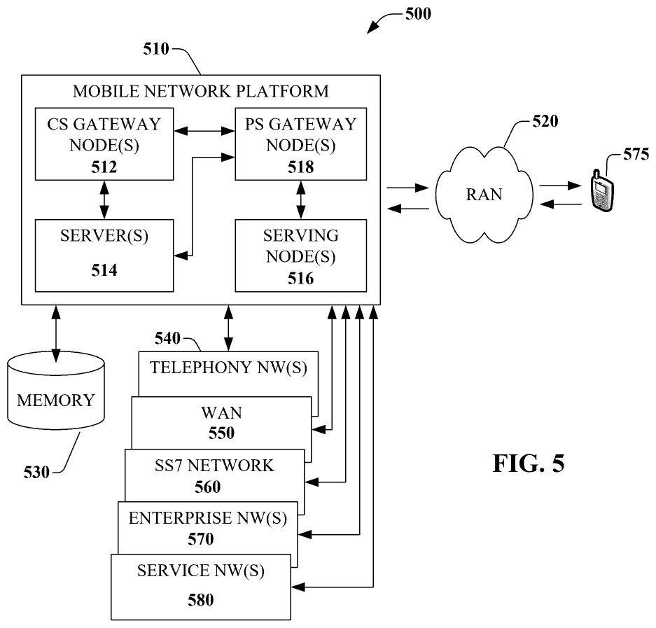

Turning now to FIG. 5, an embodiment 500 of a mobile network platform 510 is shown that is an example of network elements 150, 152, 154, 156, and/or VNEs 330, 332, 334, etc. For example, platform 510 can facilitate, in whole or in part, integrated communication and sensing network services. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, which facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as distributed antenna networks that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

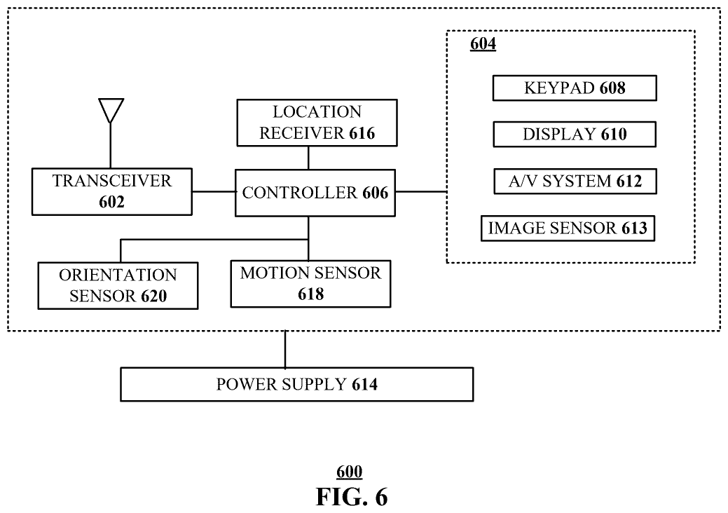

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via communications network 125. For example, computing device 600 can facilitate, in whole or in part, integrated communication and sensing network services.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VOIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communications network) can employ various AI-based schemes for conducting various embodiments thereof. Moreover, the classifier can be employed to determine a ranking or priority of each cell site of the acquired network. A classifier is a function that maps an input attribute vector, X=(x1, x2, x3, x4, . . . , xn), to a confidence that the input belongs to a class, that is, f (x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communications network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to,” “coupled to,” and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized. It is also to be understood and appreciated that the subject matter in one or more dependent claims may be combined with that in one or more other dependent claims.

What is claimed is:

1. A device, comprising:
a processing system including a processor; and
a memory that stores executable instructions that, when executed by the processing system, facilitate performance of operations, the operations comprising:
determining, based on an identified context, that there is a need for sensor-related operations;
mapping the need to one or more sensors;
receiving, from the one or more sensors, data associated with the sensor-related operations, resulting in received data;
performing analytics on the received data by applying one or more filters thereto; and
causing operational adjustments to be made to the one or more sensors based on the analytics.

2. The device of claim 1, wherein the context is identified based on a request from one or more user devices or systems.

3. The device of claim 1, wherein the context is identified based on historical information associated with one or more users or systems.

4. The device of claim 1, wherein the one or more sensors comprise Internet-of-Things (IoT) devices.

5. The device of claim 1, wherein the determining that there is the need for sensor-related operations is based on one or more thresholds being satisfied, and wherein the operations further comprise:
based on the mapping, requesting the one or more sensors for the data associated with the sensor-related operations.

6. The device of claim 1, wherein the one or more filters comprise one or more quality filters, one or more meta filters, or a combination thereof.

7. The device of claim 1, wherein the operations further comprise generating information regarding the received data for presentation to one or more users or systems.

8. The device of claim 7, wherein the operations further comprise:
tracking user or system engagement with the information to identify sensor usefulness; and
deriving a summary concerning the user or system engagement.

9. The device of claim 1, wherein the operational adjustments comprise a change to a sensor on or off status.

10. The device of claim 1, wherein the operational adjustments comprise a change to a power level.

11. The device of claim 1, wherein the operational adjustments comprise a change to a sensor data output rate.

12. A non-transitory machine-readable medium, comprising executable instructions that, when executed by a processing system of a sensor device including a processor, facilitate performance of operations, the operations comprising:
receiving, from a sensing service provider platform, a request to perform sensing operations;
performing the sensing operations based on the request, resulting in sensor data;
transmitting the sensor data to the sensing service provider platform for analysis;
responsive to the transmitting, receiving, from the sensing service provider platform, a command, generated based on the analysis, to adjust an operation of the sensor device; and
adjusting the operation of the sensor device based on the command.

13. The non-transitory machine-readable medium of claim 12, wherein the request is received based on a mapping of the sensor device to an identified need for the sensing operations.

14. The non-transitory machine-readable medium of claim 12, wherein the operations further comprise, after the transmitting, receiving, from the sensing service provider platform, a qualification or validation rating that is determined based on user or system engagement relating to the sensor data.

15. The non-transitory machine-readable medium of claim 12, wherein the operations further comprise receiving information regarding a performance of at least one other sensor device.

16. The non-transitory machine-readable medium of claim 15, wherein the operations further comprise modifying another operation of the sensor device based on the information.

17. A method, comprising:
determining, by a processing system including a processor, and based on an identified context, that there is a need for sensor-related operations in a particular environment;
mapping, by the processing system, the need to one or more sensors located in the particular environment;
obtaining, by the processing system, and from the one or more sensors, data associated with the sensor-related operations, resulting in obtained data;
performing, by the processing system, analytics on the obtained data by applying one or more filters thereto; and
causing, by the processing system, operational adjustments to be made to the one or more sensors based on the analytics.

18. The method of claim 17, wherein the context is identified based on a request from one or more user devices or systems, historical information associated with one or more users or systems, or a combination thereof.

19. The method of claim 17, wherein the one or more sensors comprise Internet-of-Things (IoT) devices.

20. The method of claim 17, further comprising generating, by the processing system, information regarding the obtained data for presentation to one or more users or systems.
